(19) United States
(12) Patent Application Publication
(10) Pub. No.: US 2008/0282988 A1
(43) Pub. Date: Nov. 20, 2008

(54) Pet entertainment system

(76) Inventor: Carl Bloksberg, Millburn, NJ (US)

Correspondence Address: FRANCIS EDWARD MARINO, 394 MEREDITH NECK ROAD, MEREDITH, NH, 03253, US

(21) Appl. No.: 11/803,162

(22) Filed: May 14, 2007

(51) Int. Cl. A01K 1/10

(52) U.S. Cl. 119/51.02; 119/174; 119/712

(57) ABSTRACT

A remotely-controllable and Internet-based pet entertainment and training system includes an at-home pet interaction device connected to a smart controller, such as a home PC, which in turn is connected through the Internet to any remote PC at which the pet owner may input commands. The system allows the owner to interact in real-time with his pet to mete out punishments, rewards, and food and drink. The system encourages well behaved pets, increases stimulus and positive interaction, and assures peace of mind to pet owners.

### FIELD OF THE INVENTION

The present invention is related to pet entertainment and training and to Internet-operated devices and systems.

### BACKGROUND AND OBJECTS OF THE INVENTION

There exists an age-old need for improved devices and systems to entertain and train pets when the pet owners are away.

There exists a desire in owners for such entertainment and training to be interactive even though the pet and owner may be quite distant from each other.

Recent studies have shown that pets that have no interaction with their owners for extended periods of time are prone to destructive behavior.

There exists a need not found in the prior art for allowing a pet owner to interact with his pet during periods of separation which mimics face-to-face interaction, for the benefit of both the owner and the pet.

### SUMMARY OF THE INVENTION

The present invention is a system which allows a pet owner to interact with his pet during periods of physical separation which closely mimics face-to-face interaction.

Through the Internet, on-line cameras, and robotics, the present system allows a pet owner to monitor his pet's behavior to judge when interaction is needed, to initiate activities suitable at that time, to interact with his pet visually, verbally, and physically, and to observe the results of this interaction.

More specifically, the present invention is an Internet-operated remote controlled system including an on-line camera, microphones and speakers, and robotic mechanisms controlled via commands sent remotely from the owner over the Internet to effect activities in the home for the benefit of the pet.

The system allows the pet owner to watch his pet at home while the owner is away via a web cam, thereby deciding when to initiate interaction. The owner can talk to and listen to the pet via speakers and microphones at each end of the Internet connection. The owner can cause robotic actions such as feeding, dispensing or activating a play toy, opening a pet door, etc, via simple Internet commands. And the owner can observe that the activities have satisfied the pet, providing peace of mind that has heretofore been unachievable.

Using the present invention, the pet's behavior may be monitored and feedback may be administered directly by the owner at the owner's discretion, either in real-time or according to a program, interval, or schedule. Visual confirmation of the proper affect and consequence may be confirmed. If, for instance, the owner is trying to train a dog to only bark when necessary, the owner using the present system may punish the dog for nuisance barking but reward the dog for barking at an intruder, a feature previously available only in face-to-face training systems.

Alternative system embodiments may be connected via one or more network connections to a smart controller, such as a limited-function PC. The smart controller may be connected to a wide area network, such as the Internet, and may communicate with a central server to allow the user a convenient front-end interface, such as a web page, to operate the device. The system may be controlled by mobile devices and/or by messaging, such as text messaging, emailing or instant messaging.

The system allows a pet owner to interact in real-time, or in absentia with his pet . . . immediately, or at a pre-arranged later time. If in real-time operation the owner witnesses that the pet is behaving improperly, he may punish the pet immediately. Alternatively, he may reward the pet for good behavior. The system encourages well-behaved pets, increases the stimulus to pets and provides positive interaction between pet and owner, and builds a stronger bond between pet and owner.

Further advantages of the various embodiments of the system will be seen in the following detailed description, accompanied by the appended drawings.

### BRIEF DESCRIPTION OF THE DRAWINGS

FIG. 1 is a diagram representing a typical installation of a system which allows a pet owner to interact remotely with his pet;

FIG. 2 is an illustration of the computer control screen of the system of FIG. 1;

FIG. 3 is an illustration of a multi-compartmented dispensing station for use within the system of FIG. 1;

FIG. 4 is an illustration of a second dispensing station for use within the system of FIG. 1 employing a dispensing auger;

FIG. 5 is an illustration of a station for use within the system of FIG. 1 which controls toys; and

FIG. 6 is an illustration is a station for use within the system of FIG. 1 which transmits shock commands to a dog training collar.

### DETAILED DESCRIPTION OF THE PREFERRED EMBODIMENT

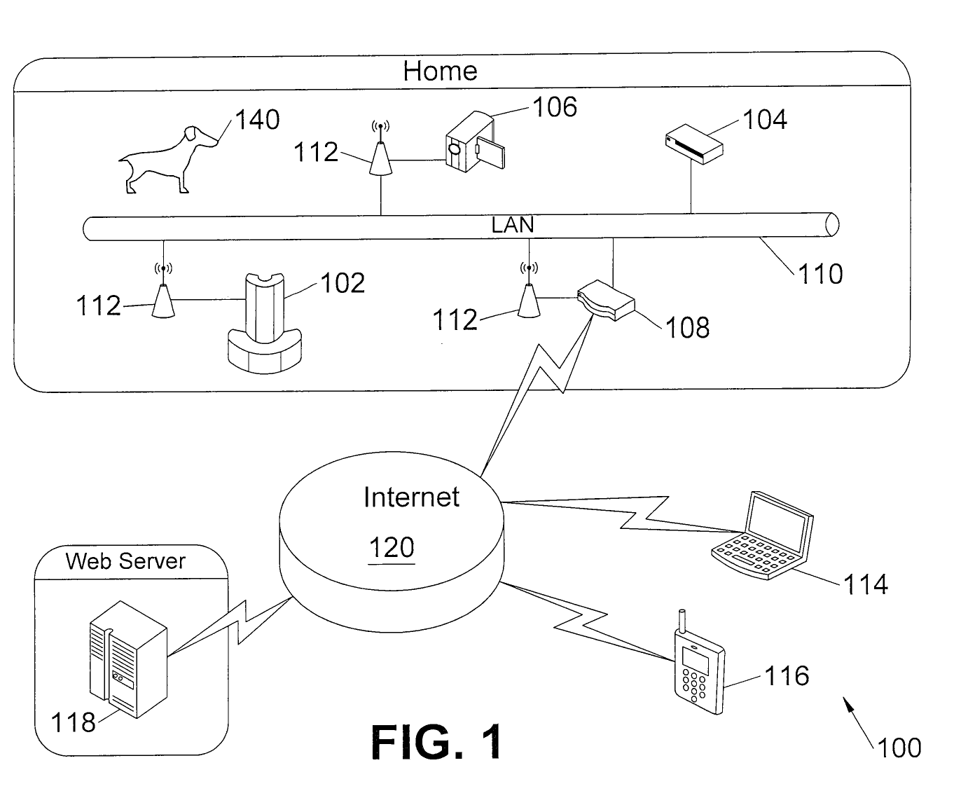

Internet operated pet entertainment and training systems according to several of the infinite number of potential embodiments of the invention are depicted in FIGS. 1 through 6. Such systems include; a remotely located terminal configured for inputting an interaction command and transmitting the command via the Internet, an at-home interaction device configured to perform an activity directed to the pet according to a received command signal, and an at-home terminal configured to receive the command from the Internet, translate the command into the command signal, and transmit the command signal to the interaction device to thereby cause the interaction device to perform the activity. The at-home terminal may be a smart controller, such as a limited-function internet accessible PC.

It should be appreciated that, while various embodiments of the invention are disclosed, combinations of any or all of the disclosed embodiments and features are anticipated and may fall within the scope of the invention, as may other embodiments not disclosed but within the limits of the claims appended hereto.

Referring first to FIG. 1, there is shown a schematic representation of a preferred system 100 and a typical pet 140. System 100 comprises both at-home and remote components, and the Internet 120. In the home, one or more pet entertainment centers 102, a smart controller 104, such as a home or limited-function Internet-capable computer, one or more web cameras 106, and an Internet router 108 are connected, either in total or in some sub-combination, to a limited-access network (LAN) 110, either by direct connections or through a wi-fi communications sub-system employing wireless transmission means of any suitable type 112.

At some remote location, which may be anywhere in the world were Internet access is available, the system includes at least one Internet-based input means, represented in this disclosure by Internet-capable remote computer 114, Internet-capable mobile PDA 116, or web server 118, which again may access the Internet 120 via a direct or wireless connection so that the pet's owner may input commands into system 100.

Each pet entertainment center 102 may comprise or control one or a combination of many possible pet-interacting devices, such as a pet treat dispensing station configured to release some or all of its contents upon a command received from the pet owner via the Internet. Some of the many optional pet-interacting devices will be discussed in greater detail later in the disclosure. Although not shown in FIG. 1, such pet interacting devices form integral elements of system 100, as will be appreciated upon further review of the disclosure.

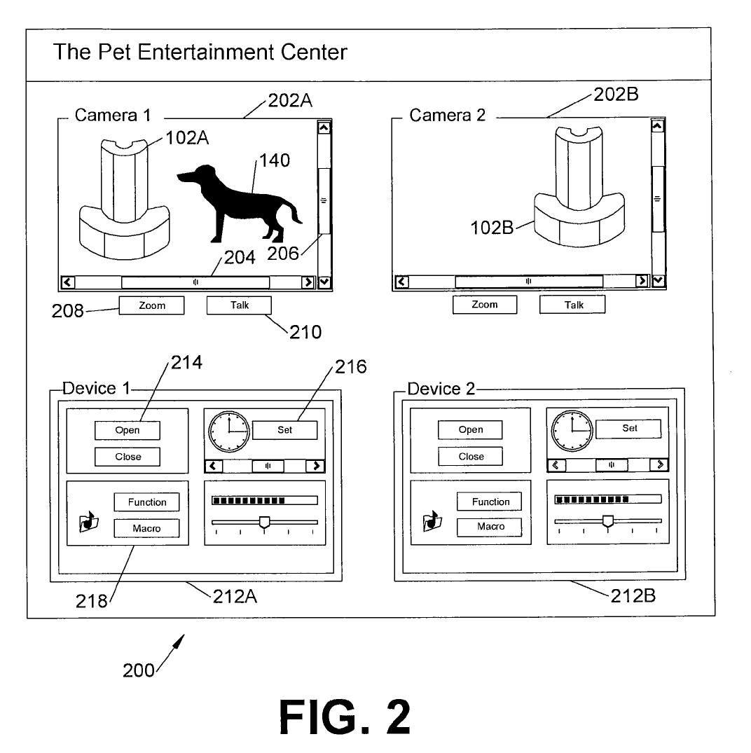

Referring to FIG. 2, there is shown a typical control screen 200 seen by the pet's owner upon accessing system 100 via the Internet through remote computer 114. In this case, two pet entertainment centers 102A and 102B are viewable via the Internet through two web cameras (not shown), and functions of the cameras and centers 102A and 102B are individually controllable by commands either programmed or inputted in real-time via the control screen.

For example, the remote pet owner may observe the vicinity of pet entertainment center 102A through camera 1 image 202A, may scan the image horizontally by moving left/right control tab 204 and vertically by moving up/down control tab 206 until pet 140 is located. The owner may zoom the image in and out though zoom button 208. Assuming for this example that the owner notices that pet 140 is acting bored and restless, the owner my talk to the pet via a speaker in center 102A by “pressing” talk button 210 while talking into a microphone at the input device 114. Upon hearing his master's voice and soothing statements, pet 140 becomes at ease.

Assuming pet entertainment center 102A includes a treat dispensing feature as will be taught later in the disclosure, the pet's owner may use the device 1 control 212A for center 102A to release a treat to pet 140, either immediately by “pressing” the open button 214, or at some desired later time by programming timer 216. Other functions may be controlled through function control 218, such as the scheduling of meals, treats, pre-recorded talks, music programs, etc, either according to time or some other event occurrence, and either individually, in combination, or in sequence.

Pet entertainment center 102B may separately be viewed through camera 2 image 202B and controlled via device 2 control 212B.

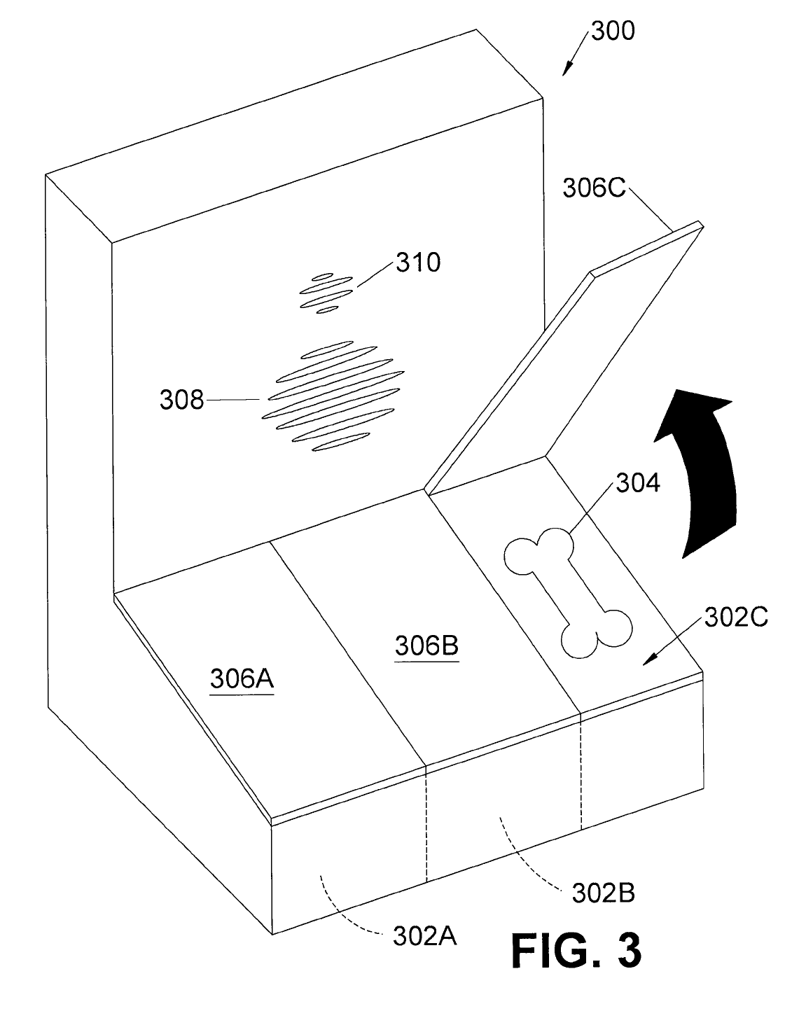

Referring now to FIG. 3, a pet entertainment station 300 is shown which allows the pet owner to speak to, listen to, and dispense three separate items to the pet, either individually, in combination, or in sequence. The station may be configured for fastening securely to a wall or fence, or may be positioned on the floor for optimal pet-access. The station may be directly connected or may include a transmitter/receiver to communicate wirelessly with the remaining system. The station's housing 308 preferably conceals all wires to provide safety for the pet. The housing may be waterproof for outdoor use. The station may be battery operated or may plug into a power supply via a power cord.

Dispensing station 300 has three compartments, 302A through 302C, for holding items to be dispensed to the pet, for example; food, water, toys or treats, represented here by dog bone 304. The compartments may have liners that may be removed for cleaning or refrigeration. Each compartment has a cover, 306A through 306C, which can each be independently opened upon an Internet command from the owner. The doors may be opened by an opening means, such as an electric motor, or a releasing means, such as a solenoid-operated latch, upon a command from the owner to dispense the contained object. Such a latch may normally act to hold the door shut, and the latch may operate upon the command to release the door which may be biased to an open state by means such as a spring.

Station 300 also includes a speaker 308, through which verbal commands, words of praise, or other sounds, can be transmitted to the pet, and a speaker 310, so that the owner may hear any barking or other noises being made by or near the pet.

The speaker and microphone may be used with almost any pet interaction device of the disclosed system to provide live or pre-recorded messages in the owner's voice to the pet, such as “No!” or “Good Boy!”, to thereby reinforce the current command and/or to allow the owner to interact audibly with his pet.

As can be appreciated, station 300 is thereby used both to store and conceal the objects to be dispensed, such as when the owner wishes to reward the pet for or to “bribe” the pet towards good behavior. Additionally, the release of the objects may be pre-programmed, timed, or made to occur automatically upon the speaker's receipt of a certain audible signal, all while the owner is in some distant location.

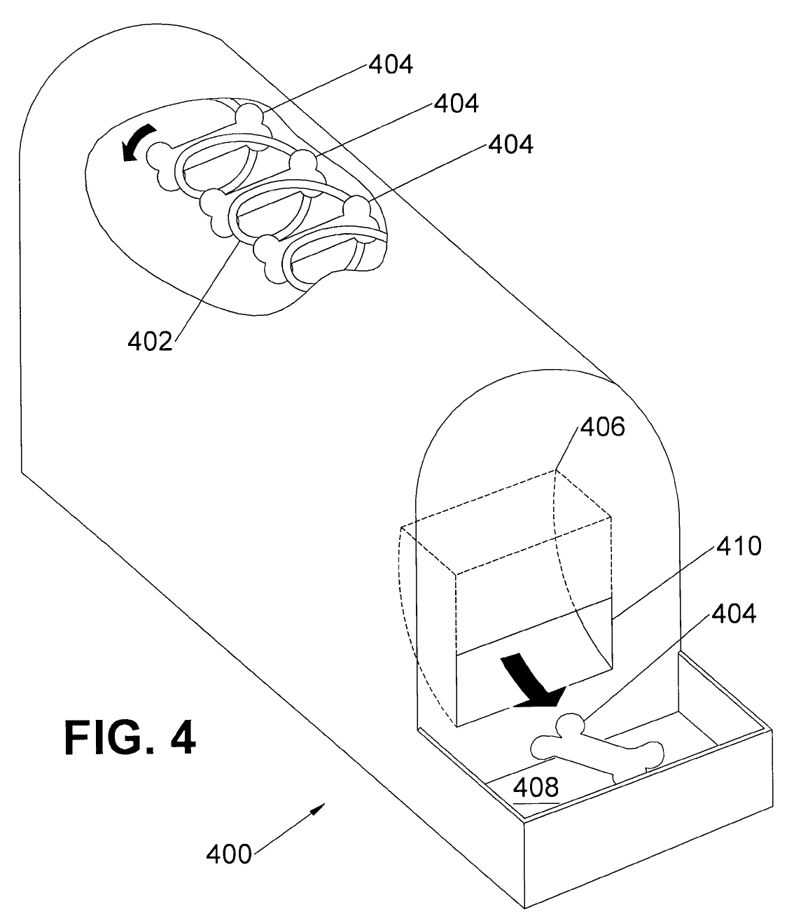

Referring now to FIG. 4, an alternate embodiment of a dispensing station 400 is shown which contains numerous objects, such as dog bones 404, that are held inside the station and dispensed upon command by an auger 402, similar to those augers used in common snack vending machines. When auger 402 is stationary, the bones 404 are held in place. When the auger is rotated one revolution, such as by an electric motor, it pushes one bone forward to where it falls into a chute 406 and is dispensed into a dispensing area 408 through slot 410, where the pet can reach it. Such a command to rotate the auger may be made in real-time or may be pre-programmed as previously described.

The dispensing station may alternatively employ a push rod, like a “Pez” candy dispenser. When the rod is extended by a solenoid or motor, it pushes the object to be dispensed forward to a dispensing area which is accessible by the pet.

In all of the anticipated dispensing stations, the objects dispensed would be unreachable by the pet until dispensed upon a real-time or pre-scheduled command.

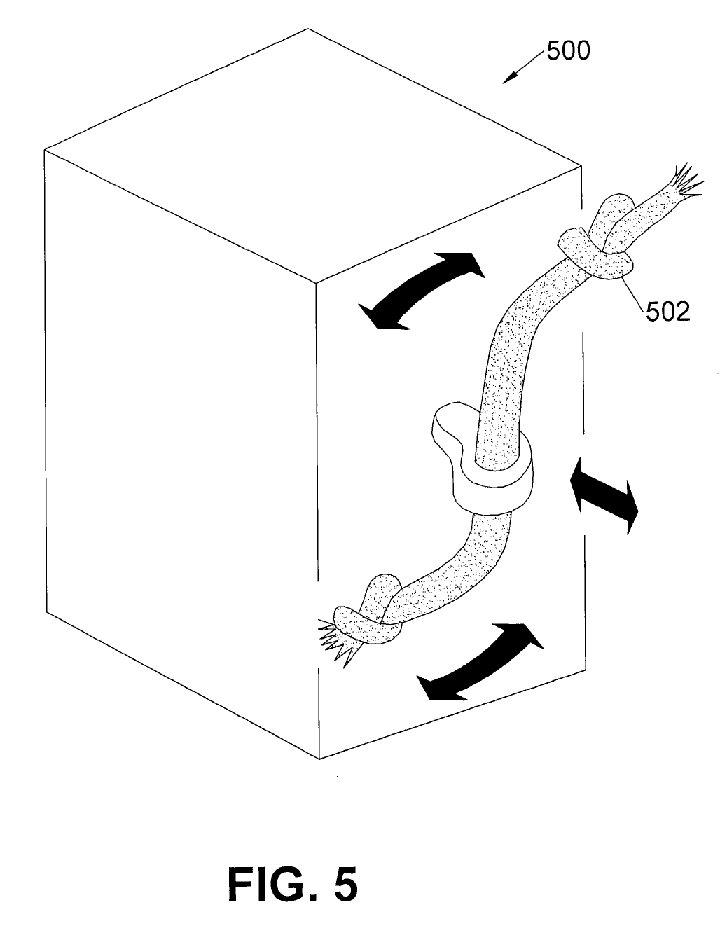

An alternate entertainment device 500 is shown in FIG. 5, which includes means for controlling a toy 502. The toy may be attached to an electric motor, a solenoid, or some other means for imparting motion to the toy upon receipt of a command from the system. The toy is rotated and jerked in and out to attract and entice a pet to play, such as during times when the owner observes through a webcam that the pet is bored.

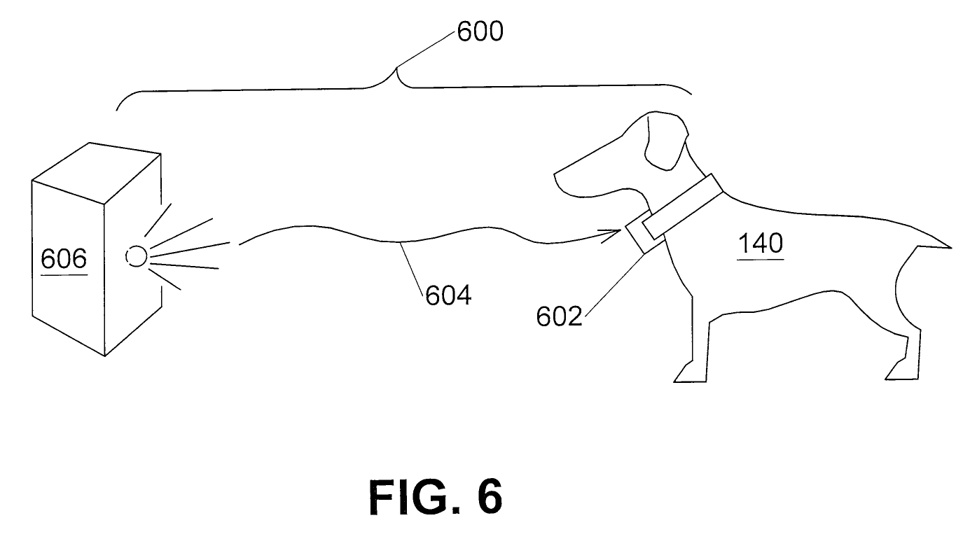

Referring next to system 600 of FIG. 6, an electric training collar 602 is used to receive a wireless signal 604 from transmission station 606, and to then provide a small electric shock to tell the pet 140 that it is doing something wrong. When the owner observes some bad behavior by the pet via a nearby webcam or speaker, the owner may send a shock signal through the Internet. Alternatively, the owner may program the system to listen for barking, according to volume or some pre-determined frequency profile, and to send a shock signal thereupon. The program improves upon existing sound-reactive “no bark” shock collars in that bark qualities specific to the targeted pet can be recognized by software in the smart controller, or the system may be programmed to operate only during certain hours, such as night time or early morning.

With all of the embodiments of dispensing, correcting, and entertaining stations, a command received at the smart controller from the Internet may be relayed to the pet interaction device via any effective connection method, such as IR, RF, hard-wired, wi-fi, Bluetooth, x10, Insteon, and Zigby.

Each device may be monitored by a webcam to allow the pet owner to see the pet and the device while it is in use. This is particularly useful in allowing the owner to not only monitor the function of the system, but to also monitor its results in training and entertaining the pet, so that the owner may adjust the activities going forward according to his observations. Preferably the video devices are capable of optical and/or digital zoom and panning.

Additionally, each device could have a display screen for the pet and a video camera at the remote location for providing an image of the owner to the pet.

The system may also send and receive two-way (or live) streaming audio. A remote controller may receive feedback from the interaction device and send controlling signals back according to the signals received.

It should be understood that the afore-described embodiments are merely examples and should not be taken to limit the invention, whose scope should only be defined by the following claims.

I claim:

1. A system for interacting from remotely with an at-home pet and comprising:
a remotely located terminal configured for inputting an interaction command and transmitting said command via the Internet;
an at-home interaction device configured to perform an activity directed to the pet according to a received command signal, and
an at-home terminal configured to receive said command from the Internet, translate said command into said command signal, and transmit said command signal to said interaction device to thereby cause said interaction device to perform said activity.

2. The system of claim 1 wherein said at-home interaction device further comprises a camera and said remotely located terminal further comprises a image viewer, and said at-home interaction device is configured to send an image signal from said at-home camera through said at-home terminal to said remotely located terminal via the Internet for viewing on said image viewer.

3. The system of claim 2 wherein said at-home interaction device further comprises an at-home microphone and said remotely located terminal further comprises a remote speaker and said at-home interaction device is configured to send a sound signal from said at-home microphone through said at-home terminal to said remotely located terminal via the Internet for hearing at said remote speaker.

4. The system of claim 3 wherein said remotely located terminal further comprises a remote microphone and said at-home interaction device further comprises an at-home speaker and said remotely located terminal is configured to send a sound signal from said remote microphone via the Internet through said at-home terminal to said at-home interaction device for hearing at said at-home speaker.

5. The system of claim 1 wherein said at-home interaction device comprises a container for storing and dispensing one of food, drink and toy for the pet and is adapted to dispense said one of food, drink and toy to the pet upon receipt of said command signal.

6. The system of claim 5 wherein said at-home interaction device further comprises a camera and said remotely located terminal further comprises a image viewer, and said at-home interaction device is configured to send an image signal from said camera through said at-home terminal to said remotely located terminal via the Internet for viewing on said image viewer.

7. The system of claim 6 wherein said at-home interaction device further comprises an at-home microphone and said remotely located terminal further comprises a remote speaker and said at-home interaction device is configured to send a sound signal from said at-home microphone through said at-home terminal to said remotely located terminal via the Internet for hearing at said remote speaker.

8. The system of claim 7 wherein said remotely located terminal further comprises a remote microphone and said at-home interaction device further comprises an at-home speaker and said remotely located terminal is configured to send a sound signal from said remote microphone via the Internet through said at-home terminal to said at-home interaction device for hearing at said at-home speaker.

9. The system of claim 1 wherein said at-home interaction device comprises a punishment metering device and is adapted to apply punishment to the pet upon receipt of said command signal.

10. The system of claim 9 wherein said at-home interaction device further comprises a camera and said remotely located terminal further comprises a image viewer, and said at-home interaction device is configured to send an image signal from said at-home camera through said at-home terminal to said remotely located terminal via the Internet for viewing on said image viewer.

11. The system of claim 10 wherein said at-home interaction device further comprises an at-home microphone and said remotely located terminal further comprises a remote speaker and said at-home interaction device is configured to send a sound signal from said at-home microphone through said at-home terminal to said remotely located terminal via the Internet for hearing at said remote speaker.

12. The system of claim 11 wherein said remotely located terminal further comprises a remote microphone and said at-home interaction device further comprises an at-home speaker and said remotely located terminal is configured to send a sound signal from said remote microphone via the Internet through said at-home terminal to said at-home interaction device for hearing at said at-home speaker.

13. The system of claim 1 wherein said at-home interaction device comprises a toy activation device adapted to cause motion to a toy upon receipt of said command signal.

14. The system of claim 13 wherein said at-home interaction device further comprises a camera and said remotely located terminal further comprises a image viewer, and said at-home interaction device is configured to send an image signal from said at-home camera through said at-home terminal to said remotely located terminal via the Internet for viewing on said image viewer.

15. The system of claim 14 wherein said at-home interaction device further comprises an at-home microphone and said remotely located terminal further comprises a remote speaker and said at-home interaction device is configured to send a sound signal from said at-home microphone through said at-home terminal to said remotely located terminal via the Internet for hearing at said remote speaker.

16. The system of claim 15 wherein said remotely located terminal further comprises a remote microphone and said at-home interaction device further comprises an at-home speaker and said remotely located terminal is configured to send a sound signal from said remote microphone via the Internet through said at-home terminal to said at-home interaction device for hearing at said at-home speaker.

17. A system for interacting from remotely with an at-home pet and comprising:
a remotely located terminal configured for inputting an interaction command and transmitting said command via the Internet, said terminal comprising an image viewer, a remote speaker, and a remote microphone;
an at-home interaction device configured to perform an activity directed to the pet according to a received command signal, said interaction device comprising a camera, an at-home microphone, an at-home speaker, and a container;
an at-home terminal configured to receive said command from the Internet, translate said command into said command signal, and transmit said command signal to said interaction device to thereby cause said interaction device to perform said activity, wherein said activity is taken from one or more of:
sending an image signal from said at-home camera through said at-home terminal to said remotely located terminal via the Internet for viewing on said image viewer;
sending a sound signal from said at home microphone through said at-home terminal to said remotely located terminal via the Internet for hearing at said remote speaker
broadcasting a sound signal from said remote microphone through said at-home speaker, and
dispensing one of food, drink and toy from said container to the pet.

18. The system of claim 1 wherein said at-home interaction device comprises a punishment metering device and is adapted to apply punishment to the pet upon receipt of said command signal.

19. The system of claim 1 wherein said at-home interaction device comprises a toy activation device adapted to cause motion to a toy upon receipt of said command signal.
